(19) United States
(12) Patent Application Publication
(10) Pub. No.: US 2026/0074408 A1
(43) Pub. Date: Mar. 12, 2026

(54) WIDEBAND DUAL DIRECTIONAL COUPLER

(71) Applicant: EXODUS COMMUNICATIONS INC., Seongnam-si (KR)

(72) Inventors: Byung Chul KIM, Gumi-si (KR); Jun Hyo PARK, Daegu-si (KR)

(21) Appl. No.: 19/290,332

(22) Filed: Aug. 4, 2025

(30) Foreign Application Priority Data
Aug. 16, 2024 (KR) 10-2024-0110105

(51) Int. Cl. H01P 5/18; H01P 5/08

(52) U.S. Cl. CPC H01P 5/183; H01P 5/085; H01P 5/184

(57) ABSTRACT

Provided is a wide band dual directional coupler including: first, second, third, and fourth ports; a main transmission line connecting the first and second ports; a first coupling circuit unit outputting a first coupled signal for a signal input to the first port to the third port; and a second coupling circuit unit outputting a second coupled signal for a signal input to the second port to the fourth port. The first coupling circuit unit includes: a first coupled line acquiring a portion of a signal traveling from the first port to the second port; a first equalizer; and a first matching resistor connected to the first coupled line. The second coupling circuit unit comprises: a second coupled line acquiring a portion of a signal traveling from the second port to the first port; a second equalizer; and a second matching resistor connected to the second coupled line.

### TECHNICAL FIELD

The present invention relates to a wide band dual directional coupler. More specifically, the present invention relates to a wide band dual directional coupler which, in a broadband of 700 MHz to 6 GHz, exhibits low transmission loss, excellent coupling characteristics and isolation characteristics, is applicable to an amplifier having an output of about CW 300 W, and is suitable for mass production.

### BACKGROUND ART

The dual directional coupler is connected to an output terminal of a power amplifier and continuously monitors whether the currently output signal maintains a desired magnitude by measuring the magnitude of the output signal. In addition, the dual directional coupler measures the magnitude of a reflected signal among the output signals and monitors the influence of the reflected signal on the amplifier.

In such dual directional couplers, a coupled line coupler is widely used. FIGS. 1A and 1B respectively show a circuit diagram of a single-stage coupled line coupler designed with a strip line according to the prior art and a graph illustrating simulated frequency characteristics thereof. Referring to FIGS. 1A and 1B, it can be seen that in the single-stage coupled line coupler designed with a strip line according to the prior art, the coupling coefficient S31 ranges from −38 dB to −45 dB depending on frequency, showing a deviation of about 7 dB.

Meanwhile, in the dual directional coupler according to the present invention, the required coupling coefficient is −44.5±1.5 dB. Accordingly, the conventional single-stage coupled line coupler falls outside the range of the coupling coefficient required in the present invention. In addition, in the single-stage coupled line coupler designed with a strip line according to the prior art, the isolation characteristics, which represents the difference between the coupling coefficient S31 of the input-side coupled port and the coupling coefficient S41 of the output-side coupled port, is favorable at 15 to 20 dB. However, the insertion loss S21 is −0.55 dB at 900 MHz and −1.9 dB at 5 GHz, which is very large.

As shown in FIGS. 1A and 1B, since the coupled line coupler fabricated with a strip line has an available frequency band of 900 MHz to 5 GHz, it is difficult to use in a wide band of 700 MHz to 6 GHz. In addition, the coupled line coupler fabricated with a strip line has difficulty withstanding an output of more than 200 W at frequencies above 3 GHz, and in particular, has disadvantages in that the deviation of the most important coupling coefficient is large and the insertion loss is very high.

In order to solve these problems, a method of increasing the number of stages of the coupled line coupler to three stages has also been proposed. FIGS. 2A and 2B respectively show a circuit diagram of a three-stage coupled line coupler designed with a strip line according to the prior art and a graph illustrating simulated frequency characteristics thereof. Referring to FIGS. 2A and 2B, in the three-stage coupled line coupler designed with a strip line according to the prior art, the coupling coefficient S31 ranges from −40 dB to −45 dB, showing a deviation of about 5 dB depending on frequency. Accordingly, although the three-stage coupled line coupler shown in FIG. 2A exhibits a reduced deviation of the coupling coefficient as compared with the single-stage coupled line coupler shown in FIG. 1A, the deviation of the coupling coefficient is still relatively large.

Meanwhile, the three-stage coupled line coupler shown in FIG. 2A has favorable isolation of 12 to 19 dB. However, the three-stage coupled line coupler shown in FIG. 2A has an insertion loss S21 of −0.22 dB at 1 GHz and −1.1 dB at 4.8 GHz, which falls outside the range of specifications required for the dual directional coupler according to the present invention. As described above, although the conventional three-stage coupled line coupler reduces the deviation of the coupling coefficient and also decreases the insertion loss compared to the single-stage coupled line coupler, it still does not meet the required specifications. However, the conventional three-stage coupled line coupler has a problem in that the available frequency band is reduced to 1 GHz to 4.8 GHz. In addition, similar to the single-stage coupled line coupler, the conventional three-stage coupled line coupler has problems in that the deviation of the coupling coefficient and the insertion loss are greater than the specifications required in the present invention.

Meanwhile, as disclosed in FIGS. 1B and 2B, in the coupled line coupler designed with a strip line according to the prior art, the coupling coefficient becomes smaller at both ends of the frequency band and larger at the center, thereby having a convex shape and lacking overall flatness. In this regard, the equalizer generally has a characteristic in which its value decreases as the frequency increases. Due to such characteristics of the equalizer, even when the equalizer is applied to the conventional coupled line coupler having the above-described coupling coefficient characteristics, there is a disadvantage in that it is very difficult to reduce the deviation of the coupling coefficient and correct the coupling coefficient to be flat. In addition, the conventional coupled line coupler designed with the strip line according to the prior art is not only difficult to use in the wide band of 700 MHz to 6 GHz, but also has an insertion loss much greater than 0.1 dB, thereby generating a large amount of heat. The heat generated in the conventional coupled line coupler designed with the strip line reduces the output, degrades the characteristics of the coupled line coupler, and, as the usage time increases, also increases the possibility of damaging the line.

In order to solve these problems, a method of using a transmission line in the form of a coaxial cable instead of the strip line has been proposed. When the coupled line coupler uses a transmission line in the form of a coaxial cable, it can be used even with an output of a power amplifier of more than CW 300 W, and the insertion loss can also be made small.

However, even when the coupled line coupler uses a transmission line in the form of a coaxial cable, an equalizer must be used in order to reduce the deviation of the coupling coefficient in the wide band of 700 MHz to 6 GHz. In addition, in order to improve flatness in the 700 MHz band, the coupled line coupler must use an equalizer employing a plurality of coil-type inductors. However, since it is difficult to manufacture coil-type inductors so that the number of turns, diameter, and length have precise values, there is a problem in that mass production becomes difficult.

Accordingly, there is an urgent need to develop a wide band dual directional coupler which satisfies coupling characteristics and isolation characteristics in the desired frequency band of 700 MHz to 6 GHz, ensures high mass productivity, and generates almost no heat even at high output of more than CW 300 W with low insertion loss.

### SUMMARY OF THE INVENTION

In order to solve the above-described problems, it is an object of the present invention to provide a wide band dual directional coupler which, in a wide frequency band of 700 MHz to 6 GHz, has a low insertion loss of 0.1 dB or less, coupling characteristics with a flat coupling coefficient of −44.5±1.5 dB, isolation characteristics of 10 dB or more over the entire frequency band, is applicable to an amplifier having an output of more than CW 300 W, and has improved mass productivity.

In order to achieve the above technical objects, a wide band dual directional coupler according to an aspect of the present invention comprises: first, second, third, and fourth ports; a main transmission line connecting the first and second ports; a first coupling circuit unit coupled to the main transmission line and outputting a first coupled signal for a signal input to the first port to the third port; and a second coupling circuit unit coupled to the main transmission line and outputting a second coupled signal for a signal input to the second port to the fourth port. And, the first coupling circuit unit comprises: a first coupled line coupled horizontally from the main transmission line and acquiring a portion of a signal traveling from the first port to the second port; a first equalizer; a transmission line 1-1 connecting one end of the first coupled line to one end of the first equalizer; a transmission line 1-2 connecting the other end of the first equalizer to the third port; and a first matching resistor connected to the other end of the first coupled line, whereby the first coupled signal is output to the third port. In addition, the second coupling circuit unit comprises: a second coupled line coupled horizontally from the main transmission line and acquiring a portion of a signal traveling from the second port to the first port; a second equalizer; a transmission line 2-1 connecting one end of the second coupled line to one end of the second equalizer; a transmission line 2-2 connecting the other end of the second equalizer to the fourth port; and a second matching resistor connected to the other end of the second coupled line, whereby the second coupled signal is output to the fourth port.

In the wide band dual directional coupler according to the above aspect, it is preferable that the main transmission line is formed of a coaxial line, and the first and second coupling lines are formed of microstrip lines.

In the wide band dual directional coupler according to the above aspect, it is preferable that the first and second equalizers are composed of RLC elements and are configured to allow adjustment of inductance by using inductors formed as integrated circuit elements.

In the wide band dual directional coupler according to the above aspect, the first and second coupled lines are preferably formed with lengths smaller than one-quarter wavelength λ/4 of a center frequency.

In the wide band dual directional coupler according to the above aspect, it is preferable that the main transmission line has a characteristic impedance of 50 Ω, and the characteristic impedances of the first and second coupling lines are identical to those of the transmission lines 1-1, 1-2, 2-1, AND 2-2.

In the wide band dual directional coupler according to the above aspect, it is preferable that the first port is an input port, the second port is an output port, the third port is a forward coupled port, and the fourth port is a reverse coupled port.

The wide band dual directional coupler according to the present invention having the above-described configuration is implemented such that a main transmission line connecting an input port P1 and an output port P2 is realized as a coaxial line, and short first and second coupled lines are realized as microstrip lines. As a result, in the wide band dual directional coupler according to the present invention, magnetic coupling occurs while exerting only a minimal influence on the signal passing through the main transmission line. Therefore, the wide band dual directional coupler according to the present invention can minimize the loss generated in the line itself over the entire operating frequency band, and thus can also minimize heat generation. Accordingly, the present invention can provide a wide band dual directional coupler having excellent performance that withstands heat and maintains unchanged insertion loss and coupling characteristics even at high power of about 300 W in the range of 700 MHz to 6 GHz. In addition, the wide band dual directional coupler according to the present invention can be used in high-power amplifiers of more than CW 300 W.

In addition, the wide band dual directional coupler according to the present invention couples first and second coupled lines to the main transmission line. The first coupled line outputs a portion of a signal input from the input port and passing through the main transmission line to a connector connected to a first coupled port P3 via a first equalizer. As a result, the wide band dual directional coupler according to the present invention can measure a forward coupled signal. The second coupled line outputs a portion of a signal reflected from a load and input to the output port of the main transmission line and passing through the main transmission line to a connector connected to a second coupled port P4 via a second equalizer. As a result, the wide band dual directional coupler according to the present invention can measure a reverse coupled signal. Accordingly, the wide band dual directional coupler according to the present invention maintains insertion loss at 0.1 dB or less over the entire band, while both the forward coupled signal and the reverse coupled signal can fall within the range of −44.5±1.5 dB. In addition, the wide band dual directional coupler according to the present invention can maintain isolation of 10 dB or more over the entire frequency band between the forward coupled signal and the reverse coupled signal output from the third port and the fourth port, respectively.

Meanwhile, in the wide band dual directional coupler according to the present invention, the first and second equalizers use inductors configured as integrated circuit elements, thereby enabling adjustment of the inductance of the inductors and, as a result, improving the mass productivity of the product.

### BRIEF DESCRIPTION OF THE DRAWINGS

FIGS. 1A and 1B respectively show a circuit diagram of a single-stage coupled line coupler designed with a strip line according to the prior art and a graph illustrating simulated frequency characteristics thereof.

FIGS. 2A and 2B respectively show a circuit diagram of a three-stage coupled line coupler designed with a strip line according to the prior art and a graph illustrating simulated frequency characteristics thereof.

FIG. 3 is a block diagram showing a wide band dual directional coupler according to a preferred embodiment of the present invention.

FIG. 4 is a circuit diagram illustrating an example of an equalizer in the wide band dual directional coupler according to the preferred embodiment of the present invention.

FIGS. 5A, 5B, and 5C are a plan view, a front view, and a left side view, respectively, showing an external appearance of the wide band dual directional coupler according to the preferred embodiment of the present invention.

FIG. 6 is a plan view showing an internal structure of the wide band dual directional coupler according to the preferred embodiment of the present invention.

FIG. 7 is a graph showing signal characteristics transmitted between the first port P1 as an input port and the second port P2 as an output port in the wide band dual directional coupler according to the preferred embodiment of the present invention.

FIG. 8 is a graph showing signal characteristics transmitted from the first port P1 as an input port to the third port P3 as a forward coupled port, and transmitted from the second port P2 as an output port to the fourth port P4 as a reverse coupled port, in the wide band dual directional coupler according to the preferred embodiment of the present invention.

FIG. 9 is a graph showing a reflection coefficient S11 at the first port P1 as an input port and a reflection coefficient S33 at the third port P3 as a forward coupled port in the wide band dual directional coupler according to the preferred embodiment of the present invention.

FIG. 10 is a graph showing S31 and S41, which indicate an isolation coefficient between the third port P3 as the forward coupled port and the fourth port P4 as the reverse coupled port, in the wide band dual directional coupler according to the preferred embodiment of the present invention.

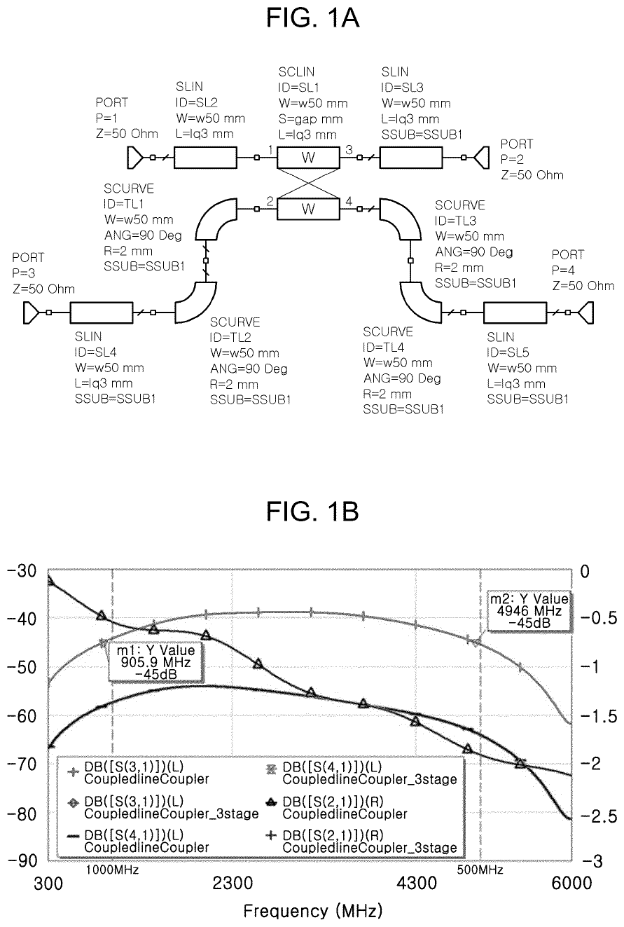

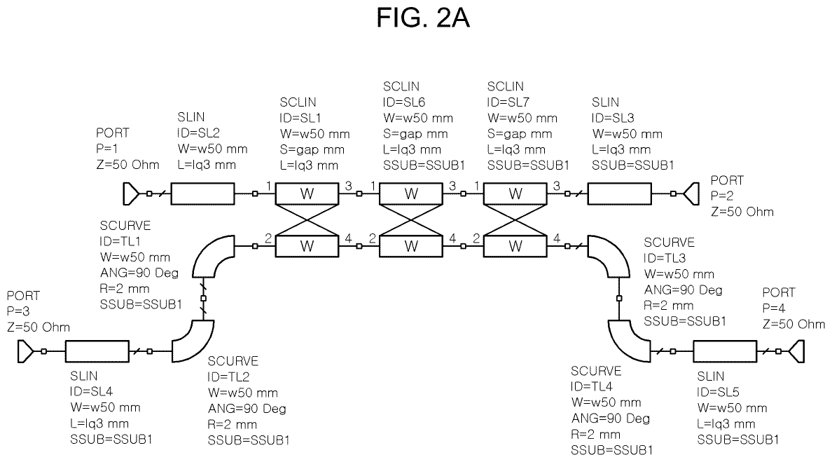

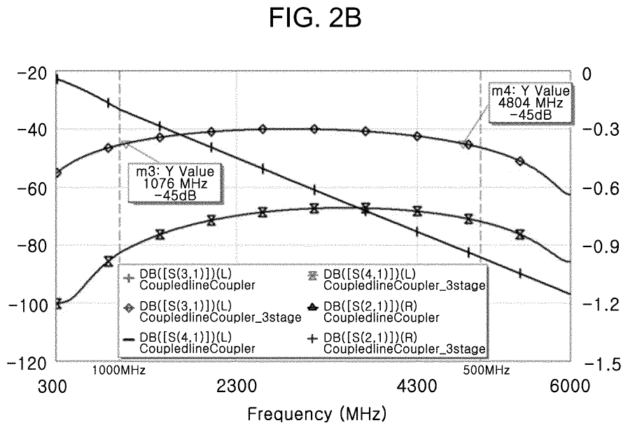

### DETAILED DESCRIPTION OF THE INVENTION

Unlike the conventional single-stage or three-stage dual directional couplers designed with a strip line, the wide band dual directional coupler according to the present invention is configured such that the main transmission line is composed of a coaxial line, the coupled lines are composed of microstrip lines, and the equalizers are composed of equalizers using inductors configured as integrated circuit elements. As a result, the wide band dual directional coupler according to the present invention is characterized by providing low insertion loss, coupling characteristics with a flat coupling coefficient, a small reflection coefficient, and excellent isolation characteristics over the entire frequency band.

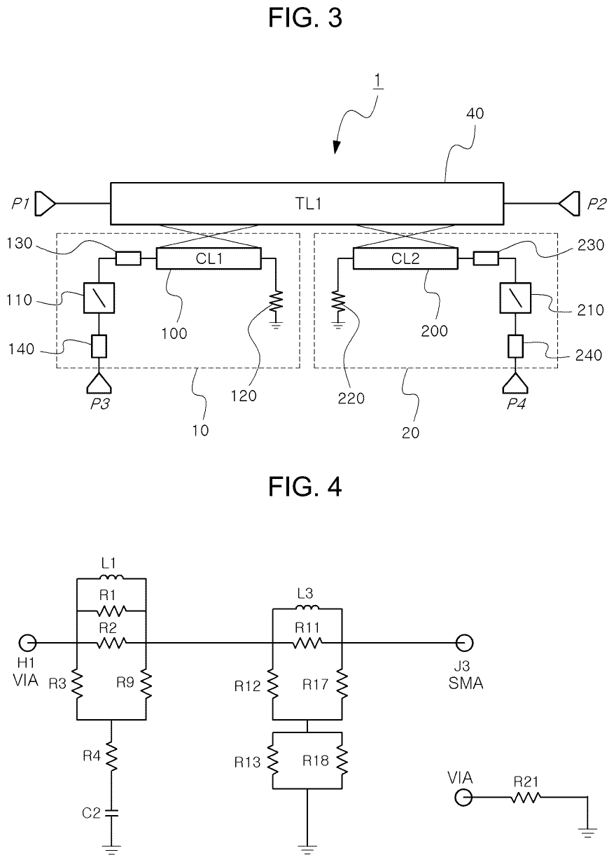

Hereinafter, configurations and operations of the wide band dual directional coupler according to the preferred embodiment of the present invention will be described in detail with reference to the accompanying drawings. FIG. 3 is a block diagram showing a wide band dual directional coupler according to the preferred embodiment of the present invention. Referring to FIG. 3, the wide band dual directional coupler 1 according to the preferred embodiment of the present invention includes first, second, third, and fourth ports P1, P2, P3, and P4, a main transmission line 40 connecting the first port and the second port, a first coupling circuit unit 10, a second coupling circuit unit 20, and a housing 30.

In one embodiment of the wide band dual directional coupler according to the present invention, the first port P1 may be used as an input port, the second port P2 may be used as an output port, the third port P3 may be used as a first coupled port serving as a forward coupled port, and the fourth port P4 may be used as a second coupled port serving as a reverse coupled port. Therefore, in the present specification, for convenience, the first, second, third, and fourth ports are described as being used as an input port, an output port, a forward coupled port, and a reverse coupled port, respectively, but the functions of the respective ports are not intended to be limited thereto. In addition, depending on embodiments of the present invention, the ports may be used in other forms.

The first coupling circuit unit 10 and the second coupling circuit unit 20 are both coupled to the main transmission line. The first coupling circuit unit 10 outputs, to the third port P3 serving as a forward coupled port, a coupled signal corresponding to a portion of a signal that travels from the first port P1 as an input port to the second port P2 as an output port. The second coupling circuit unit 20 outputs, to the fourth port P4 serving as a reverse coupled port, a coupled signal corresponding to a portion of a signal that is reflected from a load and travels from the second port P2 as an output port to the first port P1 as an input port. The main transmission line 40, which connects the first port and the second port, may be configured as a coaxial line. It is preferable that the main transmission line is configured to have a characteristic impedance of 50 Ω, and the characteristic impedance of the first and second coupled lines are the same as the characteristic impedances of the transmission lines 1-1, 1-2, 2-1, and 2-2.

The first coupling circuit unit 10 includes a first coupled line 100, a first equalizer 110, a first matching resistor 120, a transmission line 1-1 130, and a transmission line 1-2 140. The second coupling circuit unit 20 includes a second coupled line 200, a second equalizer 210, a second matching resistor 220, a transmission line 2-1 230, and a transmission line 2-2 240. The first coupled line 100 is a line coupled horizontally from the main transmission line 40.

The first coupled line 100 acquires a portion of a signal traveling from the first port P1 to the second port P2 and provides it to the transmission line 1-1 130 connected to one end of the first coupled line 100. The signal coupled by the first coupled line passes through the transmission line 1-2, the first equalizer, and the transmission line 1-2, and is output to the third port P3. Therefore, the first coupling circuit unit outputs a forward coupled signal to the third port. The second coupled line 200 is a line coupled horizontally from the main transmission line. The second coupled line 200 acquires a portion of a signal that is reflected from a load and travels from the second port P2 as an output port to the first port P1 as an input port, and provides it to the transmission line 2-1 230 connected to one end of the second coupled line 200. The signal coupled by the second coupled line passes through the transmission line 2-1, the second equalizer, and the transmission line 2-2, and is output to the fourth port P4 as a reverse coupled port. Therefore, the second coupling circuit unit outputs a reverse coupled signal to the fourth port. The first coupled line 100 and the second coupled line 200 may be configured as microstrip lines. In addition, it is preferable that the first and second coupled lines have lengths smaller than one-quarter wavelength (λ/4) of the center frequency in order to reduce the size of the product.

As described above, in the wide band dual directional coupler according to the present invention, the main transmission line is configured as a coaxial line, and the first and second coupled lines having short lengths are configured as microstrip lines, thereby allowing magnetic coupling to occur while exerting only a minimal influence on the signal passing through the main transmission line. As a result, the wide band dual directional coupler according to the present invention can minimize the loss generated in the line itself over the entire operating frequency band, and thereby minimize heat generation. Accordingly, the dual directional coupler according to the present invention withstands heat and maintains unchanged insertion loss and coupling characteristics even at high power of about 300 W in the wide band of 700 MHz to 6 GHz. Therefore, the present invention can provide a wide band dual directional coupler having excellent performance even at high power.

The first matching resistor 120 is a resistor connected to the other end of the first coupled line 100 and serves to eliminate a signal reflected at the end of the first coupled line. The second matching resistor 220 is a resistor connected to the other end of the second coupled line 200 and serves to eliminate a signal reflected at the end of the second coupled line. It is preferable that the impedances of the first and second matching resistors be configured as 50 Ω, the same as the characteristic impedance of the main transmission line.

The first equalizer 110 and the second equalizer 210 can compensate for signal attenuation in a specific frequency band to equalize the overall signal bandwidth. A portion of a signal transmitted from a first port P1 to a second port P2 through a main transmission line 40 is coupled in the first coupling line 100 and is applied to the first equalizer EQ1, 110. In addition, a portion of a signal transmitted from the second port P2 to the first port P1 through the main transmission line 40 is coupled in the second coupling line 200 and is applied to the second equalizer EQ2, 210. Here, it is to be noted that the first port P1 is an input port of the wideband dual directional coupler 1 connected to an output of a power amplifier, and that the second port P2 is an output port of the wideband dual directional coupler 1.

The first and second equalizers 110 and 210 are constituted by RLC circuits, and among the foregoing circuits, an inductor L may be implemented as an integrated circuit element with adjustable inductance. Thus, in the wideband dual directional coupler according to the present invention, the inductors used in the first and second equalizer circuits are inductors constituted by integrated circuit elements. By using the inductors constituted by integrated circuit elements to easily and accurately adjust inductance values, it becomes possible to readily manufacture a wideband dual directional coupler having uniform characteristics. FIG. 4 is a circuit diagram illustrating an example of an equalizer in the wide band dual directional coupler according to a preferred embodiment of the present invention. Referring to FIG. 4, in the wide band dual directional coupler according to the present invention, the equalizer is configured as an RLC circuit, and the inductor uses an integrated circuit type inductor.

The transmission line 1-1 130 of the first coupling circuit unit is a transmission line connecting one end of the first coupled line to one end of the first equalizer, and the transmission line 1-2 140 is a transmission line connecting the other end of the first equalizer to the third port P3. The transmission line 1-1 130 and the transmission line 1-2 140 of the first coupling circuit unit may be configured as microstrip lines. The transmission line 2-1 230 of the second coupling circuit unit is a transmission line connecting one end of the second coupled line to one end of the second equalizer, and the transmission line 2-2 240 is a transmission line connecting the other end of the second equalizer to the fourth port P4. The transmission line 2-1 230 and the transmission line 2-2 240 may be configured as microstrip lines. In addition, the characteristic impedances of the transmission lines 1-1, 1-2, 2-1, and 2-2 may be configured to be identical to the characteristic impedances of the first and second coupled lines.

The first coupling circuit unit 10 having the above-described configuration couples the first coupled line to the main transmission line. Accordingly, the first coupling circuit unit 10 acquires a portion of a signal input from the first port P1 as an input port and passing through the main transmission line from the first coupled line, and then outputs it to the third port P3 as a forward coupled port via the equalizer. As a result, the first coupling circuit unit 10 can output a forward coupled signal.

Meanwhile, the second coupling circuit unit 20 having the above-described configuration couples the second coupled line to the main transmission line. Accordingly, the second coupling circuit unit 20 acquires a portion of a signal that is reflected from a load and input at the second port P2 as an output port of the main transmission line and passing through the main transmission line, from the second coupled line, and then outputs it to the fourth port P4 as a reverse coupled port via the equalizer. As a result, the second coupling circuit unit 20 can output a reverse coupled signal.

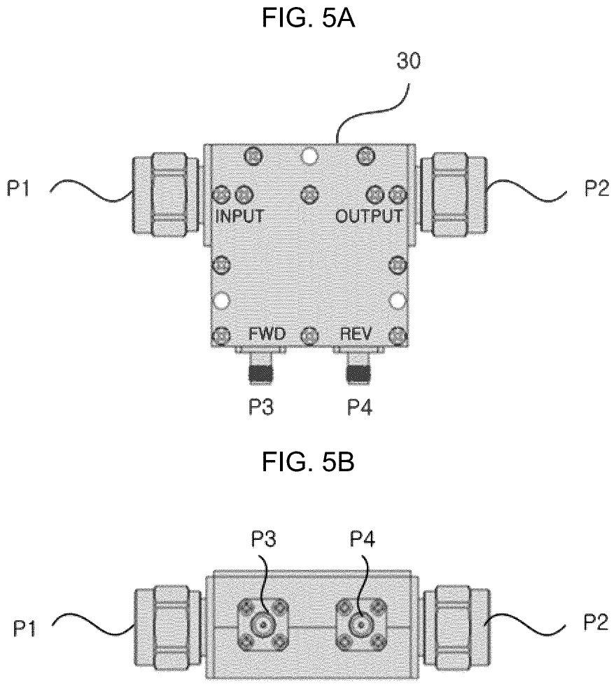

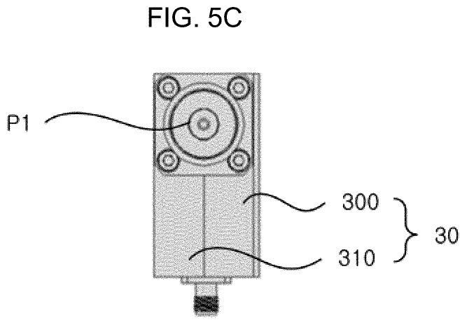

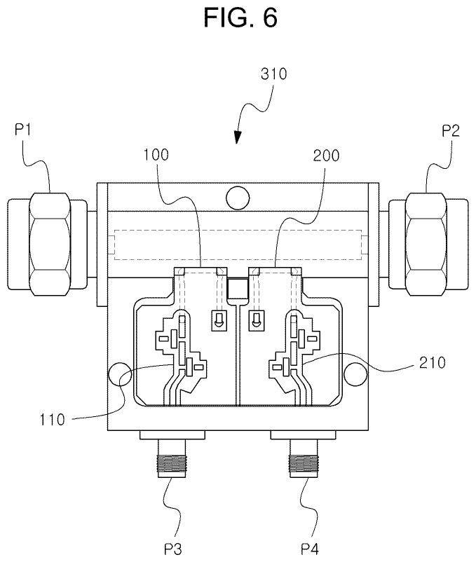

FIGS. 5A, 5B, and 5C are a plan view, a front view, and a left side view, respectively, showing an external appearance of the wide band dual directional coupler according to the preferred embodiment of the present invention. FIG. 6 is a plan view of a lower region of FIG. 5. Referring to FIGS. 5A, 5B, and 5C, the housing 30 of the wide band dual directional coupler 1 according to the present invention may be manufactured by dividing it into an upper region 300 and a lower region 310.

Referring to FIG. 6, in the lower region 310, the main transmission line 40 connecting the first port P1 as an input port and the second port P2 as an output port may be configured as a coaxial line, and the first and second coupled lines 100 and 200 and the first and second equalizers 110 and 210 may be configured as microstrip lines. It is preferable that the first port P1 as the input port and the second port P2 as the output port use N-type connectors to match the main transmission line 40 using a coaxial line. In addition, SMA connectors may be used for the third and fourth ports P3 and P4, which are respectively connected to the first and second equalizers 110 and 210.

If an output of 300 W (55 dBm) is applied in the operating frequency band, a signal having a magnitude of 13 dBm at 700 MHz and 30 dBm at 6 GHz may be applied to the first equalizer 110 connected to the input port P1. In addition, when the reflection coefficient is 20 dB, a signal reflected from the load and traveling from the output port P2 toward the input port P1 through the main transmission line 40 becomes 35 dBm, and a signal having a magnitude of −7 dBm at 700 MHz and 10 dBm at 6 GHz may be applied to the second equalizer 210 connected to the output port P2.

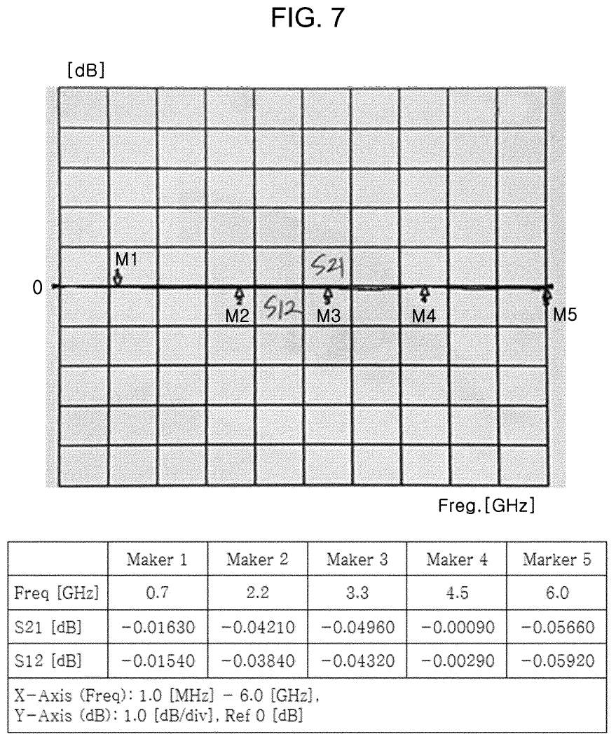

In order to examine the performance of the wide band dual directional coupler according to the preferred embodiment of the present invention as described above, it was actually fabricated, and the insertion loss, coupling characteristics, reflection coefficient, and isolation characteristics were measured and confirmed. Hereinafter, with reference to FIGS. 7 to 10, the performance of the wide band dual directional coupler according to the present invention will be described in detail.

FIG. 7 is a graph showing signal characteristics transmitted between the first port P1 as an input port and the second port P2 as an output port in the wide band dual directional coupler according to the preferred embodiment of the present invention. The insertion loss can be confirmed through FIG. 7. Referring to FIG. 7, S21, which represents the loss of a signal transmitted from the input port P1 to the output port P2, is 0.016 dB at 700 MHz and 0.0566 dB at 6 GHz, which falls within the desired specification range of 0.1 dB. In addition, S12, which represents the loss of a signal reflected from the load and transmitted from the output port P2 to the input port P1, is 0.0154 dB at 700 MHz and 0.059 dB at 6 GHz, which also falls within the desired specification range of 0.1 dB.

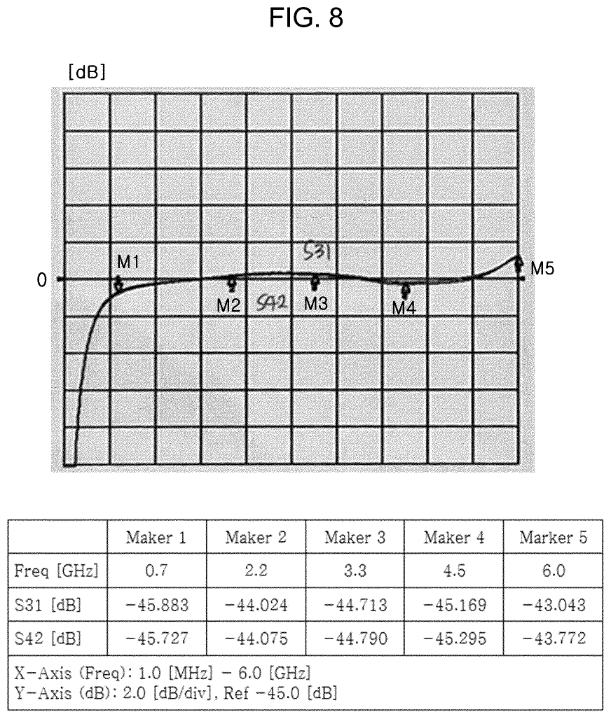

FIG. 8 is a graph showing signal characteristics transmitted from the first port P1 as an input port to the third port P3 as a forward coupled port, and transmitted from the second port P2 as an output port to the fourth port P4 as a reverse coupled port, in the wide band dual directional coupler according to the preferred embodiment of the present invention. The coupling coefficient can be confirmed through FIG. 8. Referring to FIG. 8, S31, which is a signal transmitted from the input port P1 to the forward coupled port P3, is −45 dB at 700 MHz and −43.04 dB at 6 GHz, satisfying the desired specification of −44.5±1.5 dB. In addition, S42, which is a signal transmitted from the output port P2 to the reverse coupled port P4, is −45.727 dB at 700 MHz and −43.772 dB at 6 GHz, also satisfying the desired specification.

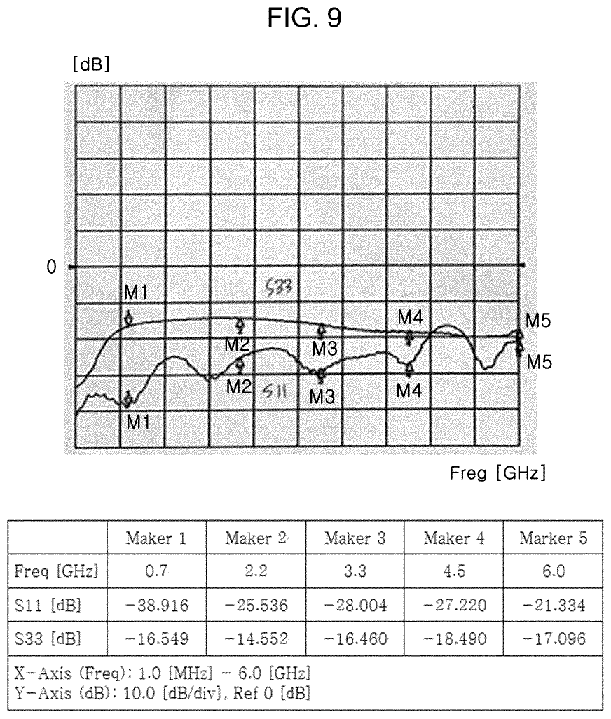

FIG. 9 is a graph showing the reflection coefficient S11 at the first port P1 as an input port and the reflection coefficient S33 at the third port P3 as a forward coupled port in the wide band dual directional coupler according to the preferred embodiment of the present invention. The return loss can be confirmed through FIG. 9. Referring to FIG. 9, the reflection coefficient S11 at the input port P1 is 16 to 38 dB over the entire frequency band, indicating excellent characteristics. In addition, the reflection coefficient S33 at the third port P3 as a forward coupled port is 14.5 to 17 dB over the entire frequency band, also indicating excellent characteristics.

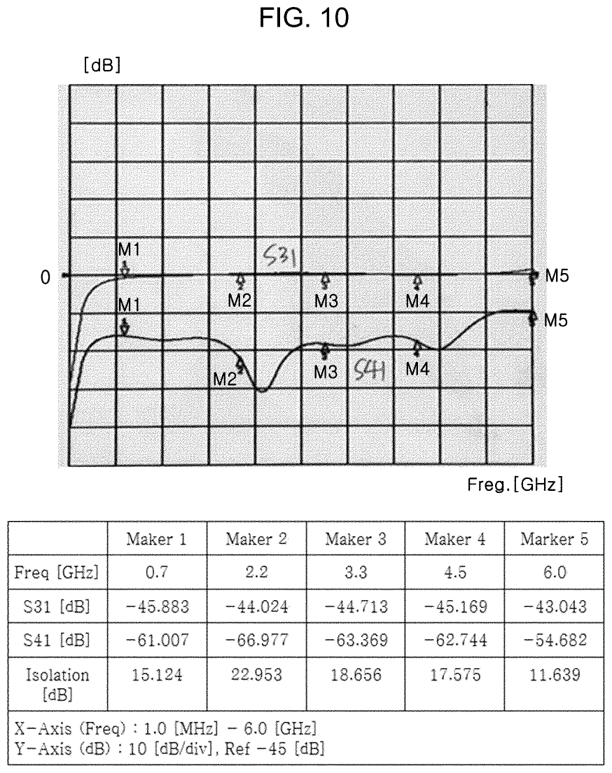

FIG. 10 is a graph showing S31 and S41, which indicate an isolation coefficient between the third port P3 as a forward coupled port and the fourth port P4 as a reverse coupled port, in the wide band dual directional coupler according to the preferred embodiment of the present invention. The isolation characteristics can be confirmed through FIG. 10. Referring to FIG. 10, the difference between the isolation coefficients S31 and S41 is 16 dB at 700 MHz and 11.6 dB at 6 GHz, indicating that the wide band dual directional coupler according to the present invention satisfies the specification that the isolation coefficient must be 10 dB or more over the entire operating frequency band.

As described above, the conventional wide band dual directional coupler using strip lines is difficult to use in a high-power amplifier. In addition, the conventional wide band dual directional coupler using strip lines is also difficult to use in an alarm circuit for the output signal magnitude and a reflected signal of a power amplifier due to its large insertion loss and large deviation of the coupling coefficient. However, the wide band dual directional coupler according to the present invention can solve the above problems by using a coaxial line and equalizers. As a result, the wide band dual directional coupler according to the present invention can be used in the alarm circuit of a high-power amplifier in a wide band. In particular, the wide band dual directional coupler according to the present invention can reduce the deviation of coupled signals according to frequency and also reduce the reflection coefficient by connecting the first and second equalizers to the first and second coupled lines, respectively. The wide band dual directional coupler according to the present invention can be applied in a simple manner to power amplifiers having various types of outputs over various frequency bands, and can be used in an alarm circuit for output signal magnitude and reflection coefficient.

While the present invention has been described above with reference to its preferred embodiments, this is merely exemplary and not intended to limit the invention. It will be understood by those skilled in the art that various modifications and applications not exemplified above can be made without departing from the essential characteristics of the present invention. Such modifications and applications, and differences related thereto, should be construed as falling within the scope of the present invention as defined in the appended claims.

What is claimed is:

1. A dual directional coupler comprising:
first, second, third, and fourth ports;
a main transmission line connecting the first and second ports;
a first coupling circuit unit coupled to the main transmission line and outputting a first coupled signal for a signal input to the first port to the third port; and
a second coupling circuit unit coupled to the main transmission line and outputting a second coupled signal for a signal input to the second port to the fourth port,
wherein the first coupling circuit unit comprises:
a first coupled line coupled horizontally from the main transmission line and acquiring a portion of a signal traveling from the first port to the second port;
a first equalizer;
a transmission line 1-1 connecting one end of the first coupled line to one end of the first equalizer;
a transmission line 1-2 connecting the other end of the first equalizer to the third port; and
a first matching resistor connected to the other end of the first coupled line, and
wherein the second coupling circuit unit comprises:
a second coupled line coupled horizontally from the main transmission line and acquiring a portion of a signal traveling from the second port to the first port;
a second equalizer;
a transmission line 2-1 connecting one end of the second coupled line to one end of the second equalizer;
a transmission line 2-2 connecting the other end of the second equalizer to the fourth port; and
a second matching resistor connected to the other end of the second coupled line.

2. The dual directional coupler according to claim 1, wherein the main transmission line is formed of a coaxial line, and the first and second coupled lines are formed of microstrip lines.

3. The dual directional coupler according to claim 1, wherein the first and second equalizers are composed of RLC elements and are configured to adjust inductance by using inductors formed as integrated circuit elements.

4. The dual directional coupler according to claim 1, wherein the first and second coupled lines have lengths smaller than one-quarter wavelength λ/4 of a center frequency.

5. The dual directional coupler according to claim 1, wherein the main transmission line has a characteristic impedance of 50 Ω, and the characteristic impedances of the first and second coupled lines are identical to the characteristic impedances of the main transmission lines 1-1, 1-2, 2-1, and 2-2.

6. The dual directional coupler according to claim 1, wherein the first port is an input port, the second port is an output port, the third port is a forward coupled port, and the fourth port is a reverse coupled port.
